(19) United States
(12) Patent Application Publication
(10) Pub. No.: US 2010/0019643 A1
(43) Pub. Date: Jan. 28, 2010

(54) Sparkplug, in Particular for High Combustion Chamber Pressures

(76) Inventors: Thomas Kaiser, Madrid (ES); Paulo Ricardo, Kirchberg An Der Murr (DE)

Correspondence Address: KENYON & KENYON LLP, ONE BROADWAY, NEW YORK, NY, 10004, US

(21) Appl. No.: 12/227,614

(22) PCT Filed: Jul. 12, 2007
(86) PCT No.: PCT/EP2007/057138

§ 371 Date: Mar. 5, 2009

(30) Foreign Application Priority Data
Jul. 19, 2006 (DE) 10 2006 033 480.9

(51) Int. Cl. H01T 13/20

(52) U.S. Cl. 313/141; 313/118

(57) ABSTRACT

A spark plug has a center electrode disposed inside an insulator, and a housing that at least locally surrounds the insulator, and a conductive planar element that is electrically contacted to the housing is disposed on the insulator.

### BACKGROUND OF THE INVENTION

1. Field of the Invention

The present invention relates to a spark plug for internal combustion engines, e.g., for use in combustion chambers having a high pressure.

2. Description of Related Art

Spark plugs are known from the existing art in a variety of configurations. The known spark plugs have proven successful in principle for use in internal combustion engines. Very recently, however, the pressures in the combustion chamber at the moment of ignition have been constantly increasing, since the internal combustion engines are being more intensely turbocharged and operated with higher compression. Especially at high pressures, creepage sparks can occur upon ignition; these can also extend, in particular, into a breathing space of the spark plug that is formed, at the combustion-chamber end of the spark plug, between a tapering region of the insulator and a housing of the spark plug. In the homogeneous mode of the internal combustion engine, such creepage sparks can cause the engine to run unevenly. In the stratified mode of the internal combustion engine and in operating states with an inhomogeneous mixture distribution, for example with low-temperature starts, creepage sparks result in the frequent occurrence of combustion misfires.

Published German patent document DE 196 50 724 discloses, in order to reduce creepage sparks, to provide an electrode spacing between the center electrode and ground electrode such that said electrode spacing is smaller than a spacing from the center electrode to the housing. The geometrical dispositions proposed in this context for the electrodes often cannot be maintained, however, as a result of parameters related to installation space.

### BRIEF SUMMARY OF THE INVENTION

The spark plug according to the present invention has the advantage that it prevents the occurrence of creepage sparks. As a result, the spark plug according to the present invention can be used especially in internal combustion engines with high pressures, such as turbocharged and/or high-compression engines. The spark plug according to the present invention exhibits a long service life and can be manufactured simply and economically. This is achieved, according to the present invention, by the fact that a conductive planar element that is electrically in contact with the housing is disposed on the insulator of the spark plug. What is achieved as a result, according to the present invention, is that the insulator surface is brought to the electrical potential of the housing. The housing is usually grounded. By way of this relatively simple action according to the present invention, electric fields that are present in conventional spark plugs, in the breathing space between the tapering insulation and the housing, are eliminated. The generation of creepage sparks can thereby be prevented even at high pressures. In addition, partial discharges in the housing land region can be avoided, and electromagnetic interference pulses can thus also be suppressed.

The conductive planar element may be embodied as a ribbon extending completely around the insulator. As a result, any production of electric fields in the critical region of the breathing space between the insulation and the housing can be reliably prevented. Be it noted that it is also possible, alternatively, to provide only partially circumferential regions with the conductive planar element according to the present invention, adjacent planar elements being spaced apart from one another to only a small extent. An electrical connection of each element to the housing must, however, be present in this context.

The conductive planar element may be disposed in the region of a sealing seat between the housing and the insulator. Secure contacting can be achieved thereby.

The spark plug may encompass a sealing ring that is disposed between the housing and the insulator, and the sealing ring is manufactured from an electrically conducting material. The conductive planar element according to the present invention is disposed in a region of the insulator that is positioned at the height of the sealing ring.

According to a further example embodiment of the present invention, the conductive planar element has a thickness of at most 100 μm. The conductive planar element is, in further preferred fashion, provided with a constant thickness. This upper limit of the thickness of the element has the advantage that simple mounting is ensured. Be it noted further that as the layer thickness becomes greater, stresses in the material rise considerably, thereby impairing mounting of the element. As an example, the thickness of the conductive planar element is in the range from approx. 50 μm to approx. 80 μm.

As an example embodiment, the conductive planar element is disposed on the insulator on a region of the insulator that, in the installed state, is located at the height of an internal circumferential land of the housing. The conductive planar element preferably covers, on the insulator, at least 70% of the surface of the insulator that is directed toward the inner land of the housing in the radial direction of the spark plug. This feature ensures that the space between the inner land of the housing and the insulator, which space is susceptible to the formation of electric fields, is at least 70% covered by the electrically conducting element. As a result, this region susceptible to predischarges can be made field-free, so that the tendency for creepage sparks to occur is reduced. Be it noted further that the conductive planar element on the insulator must not extend too far in the direction of the electrodes, since otherwise a shunt susceptibility of the spark plug is substantially increased.

Proceeding from a contact point between insulator and housing, the conductive planar element preferably covers a region of the insulator in the direction of the latter's end surface at which the electrodes are disposed, the region equipped with the conductive planar element being at most 50%, preferably 30% of the distance between the contact point and the end surface of the insulator.

The conductive planar element preferably covers at least 70% of the area of a region of the insulator that has a spacing of less than or equal to 0.5 mm from the inner surface of the housing. This likewise ensures that the region in the working space that is critical for the production of creepage sparks is made field-free.

The conductive planar element is a conductive coating, for example. This can be applied easily and economically, and has only a low density.

The coating may be a conductive paint that has an electrical conductivity. This has the advantage, in particular, that the coating can be applied particularly easily and economically. It is also not necessary in this context to modify existing installation procedures for spark plugs. The conductive paint preferably encompasses a noble metal, in particular silver and/or platinum and/or gold and/or iridium and/or rhodium, and/or tantalum and/or nickel and/or carbon, or any oxidation-resistant alloy thereof. Oxidation resistance is important because high temperatures and atmospheric oxygen are present in the combustion chamber.

A thin ribbon or a thin foil, e.g. gold leaf or another noble-metal-containing foil, can also be used as a conductive planar element.

### BRIEF DESCRIPTION OF THE SEVERAL VIEWS OF THE DRAWING

FIG. 1 is a schematic, partially sectioned partial view of a spark plug according to an exemplifying embodiment of the invention.

FIG. 2 is a diagram that shows the probability of the occurrence of creepage sparks as a function of pressure in the combustion chamber, for a spark plug according to the present invention and for a spark plug of the existing art.

### DETAILED DESCRIPTION OF THE INVENTION

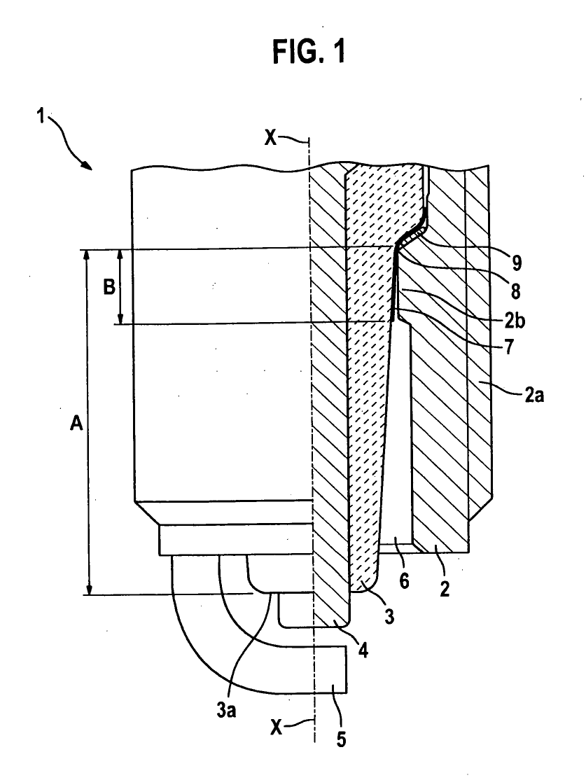

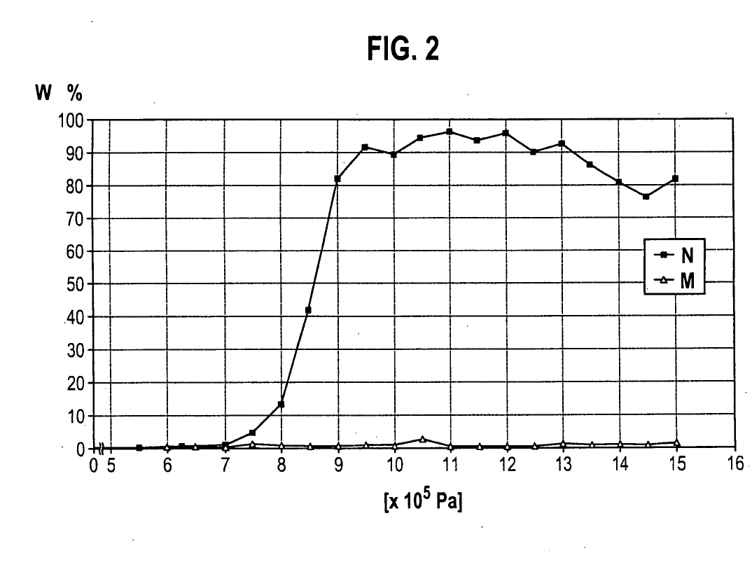

A spark plug 1 according to an exemplifying embodiment of the invention is described in detail below with reference to FIGS. 1 and 2.

As shown in FIG. 1, spark plug 1 encompasses a housing 2 that has an external thread 2a with which spark plug 1 is mounted on a component of an internal combustion engine. Spark plug 1 further encompasses an insulator 3 having an end surface 3a on the combustion-chamber side. Disposed in the interior of insulator 3 is a center electrode 4 that is disposed in the longitudinal direction X-X of the spark plug. A ground electrode 5 is connected to housing 2.

As is evident from FIG. 1, a breathing space 6 is constituted between insulator 3 and housing 2. Breathing space 6 is provided in annular fashion, and tapers from the electrode-side end of the spark plug. An internal circumferential land 2b is also configured on the inner side of housing 2. Land 2b has an annular shape, and a seal 9 is disposed between housing 2 and insulator 3 at a step transition between 1 and 2b and the inner side of the housing.

A coating 7 made of a silver conductive paint is also applied on insulator 3 at the height of land 2b. The silver conductive paint can be applied onto insulator 3, for example, by being sprayed or rolled on. Located in the region of the step at land 2b is an annular contact point 8 between housing 2 and coating 7. Contact point 8 represents an electrically conducting contact between housing 2 and coating 7, with the result that the outer surface of insulator 3 is brought, in the region of breathing space 6, to the electrical potential of the housing. It is thereby possible to prevent electric fields from building up between insulator 3 and the inner side of housing 2, which fields could cause a creepage spark to jump via end face 3a of insulator 3 into breathing space 6 during the moment of ignition. The conductive coating 7 eliminates these electric fields in the region of inner land 2b of housing 2. The occurrence of a creepage spark can thus be prevented according to the present invention, in particular at high pressures.

FIG. 2 shows, in this connection, a diagram that shows a comparison between a spark plug having an insulator without a coating, according to the existing art, and a spark plug according to the present invention having an insulator exhibiting a coating of silver conductive paint. In FIG. 2, the curve for the spark plug having an insulator without a coating is labeled “N”, and the curve for the spark plug having an insulator with a coating is labeled “M”. “W” indicates the probability (in %) of a creepage spark. As is evident from the diagram of FIG. 2, the spark plug according to the present invention exhibits, even at very high pressures, only a minimal probability for the production of a creepage spark. In contrast thereto, with the spark plug according to existing art a significant rise in the probability of occurrence of a creepage spark is evident starting at a pressure of approx. 7×10⁵ Pascal.

It is additionally evident from FIG. 1 that coating 7 is provided on insulator 3 over a width B in longitudinal direction X-X of the spark plug proceeding from contact point 8, a ratio of width B to a spacing A from contact point 8 to end surface 3a of insulator 3 being approximately 1:4. In other words, coating 7 is formed over a surface region, proceeding from contact point 8, of approx. 25 % of the insulator surface from contact point 8 to end surface 3a. As is further evident from FIG. 1, coating 7 is provided in complete fashion over the entire width of land 2b. A coverage of coating 7 in the region of land 2b should be equal to at least 70% of the land width in order render field-free the region between insulator 3 and housing 2 susceptible to the undesired predischarges. Be it noted further in this context that coating 7 on insulator 3 should amount to at most 50%, particularly preferably at most 30%, of spacing A between contact point 8 and end surface 3a.

The coating used is preferably a conductive paint that encompasses a noble metal or an oxidation-resistant conducting alloy, since very high temperatures often occur in the combustion chamber.

The present invention can be used in all known application areas for spark plugs, but is particularly suitable when high pressures occur in combustion chambers.

1-12. (canceled)

13. A spark plug, comprising:
an insulator;
a center electrode disposed inside the insulator; and
a housing that at least locally surrounds the insulator;
wherein a conductive planar element electrically contacted to the housing is disposed on the insulator.

14. The spark plug as recited in claim 13, wherein the conductive planar element is configured as a region circumferentially extending entirely around the insulator.

15. The spark plug as recited in claim 14, wherein the conductive planar element is disposed in the region of a sealing seat between the housing and the insulator.

16. The spark plug as recited in claim 15, further encompassing a seal disposed between the housing and the insulator, wherein the seal includes an electrically conducting material and contacts the housing and the conductive planar element.

17. The spark plug as recited in claim 16, wherein the conductive planar element has a thickness between approximately 50 μm and 80 μm.

18. The spark plug as recited in claim 16, wherein the conductive planar element is disposed on the insulator at the upper surface of an internal circumferential protrusion of the housing.

19. The spark plug as recited in claim 18, wherein the conductive planar element covers, on the insulator, at least 70% of a surface of the insulator that is directed toward the internal circumferential protrusion of the housing.

20. The spark plug as recited in claim 18, wherein the conductive planar element, proceeding from a contact point between the conductive planar element and the housing, covers a partial region of the insulator in its longitudinal direction, wherein the partial region is at most 50% of a spacing between the contact point and an end surface of the insulator (3).

21. The spark plug as recited in claim 18, wherein the conductive planar element is disposed on at least 70% of a region of the insulator that has a separation spacing of less than or equal to 0.5 mm from the inner surface of the housing.

22. The spark plug as recited in claim 18, wherein the conductive planar element is a conductive coating.

23. The spark plug as recited in claim 22, wherein the conductive coating includes one of silver, platinum, gold, iridium, rhodium, tantalum, nickel, carbon or an oxidation-resistant alloy.

24. The spark plug as recited in claim 21, wherein the conductive planar element is a foil containing noble metal.
